(19) United States
(12) Patent Application Publication
(10) Pub. No.: US 2017/0280034 A1
(43) Pub. Date: Sep. 28, 2017

(54) VEHICLE VISION SYSTEM CAMERA WITH ENHANCED IMAGER AND LENS ASSEMBLY

(71) Applicant: MAGNA ELECTRONICS INC., Auburn Hills, MI (US)

(72) Inventors: Holger Hess, Aschaffenburg (DE); Joern Ihlenburg, Berlin (DE); Sebastian Pliefke, Sailauf (DE); Jagmal Singh, Aschaffenburg (DE)

(21) Appl. No.: 15/460,665

(22) Filed: Mar. 16, 2017

Related U.S. Application Data
(60) Provisional application No. 62/312,128, filed on Mar. 23, 2016.

(51) Int. Cl. H04N 5/225

(52) U.S. Cl. CPC H04N 5/2257; H04N 5/2252; H04N 5/2253; H04N 5/2254

(57) ABSTRACT

A camera for a vision system for a vehicle includes a front housing portion, a lens assembly disposed at the front housing portion and an imager disposed at a circuit element. A planar rigid spacer having uniform thickness is disposed between the lens assembly and the imager. At least a circumferential portion of a front surface of the planar rigid spacer is secured at a portion of the front housing portion and at least a circumferential portion of a rear surface of the planar rigid spacer is secured at one of the imager and the circuit element. The planar rigid spacer accurately spaces the imager from the lens assembly and the predetermined thickness of the planar rigid spacer is selected so that the lens assembly focuses incident light onto the imager.

### CROSS REFERENCE TO RELATED APPLICATION

The present application claims the filing benefits of U.S. provisional application, Ser. No. 62/312,128, filed Mar. 23, 2016, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a camera and method of manufacturing a camera for a vision system or imaging system for a vehicle that utilizes one or more cameras to capture image data representative of images exterior of the vehicle. The camera comprises an imager disposed at a circuit element or printed circuit board and a lens disposed at a lens holder or front housing portion, with a glass plate or substrate disposed between the lens assembly and the imager. The imager and lens holder or lens barrel can be adhesively attached at opposite sides or surfaces of the glass plate, whereby very precise positioning of the lens relative to the imager (to optically align and center the lens at the imager) is provided by the ability to move or adjust the lens relative to the glass plate or the imager relative to the glass plate before curing of the adhesive.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a sectional view of a camera showing a known camera and lens-imager system;

FIG. 3 is a perspective view of a camera or camera module of the present invention; and

FIG. 4 is a sectional view of the camera of FIG. 3, showing a camera and lens-imager system having a glass plate disposed between the lens and the imager in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

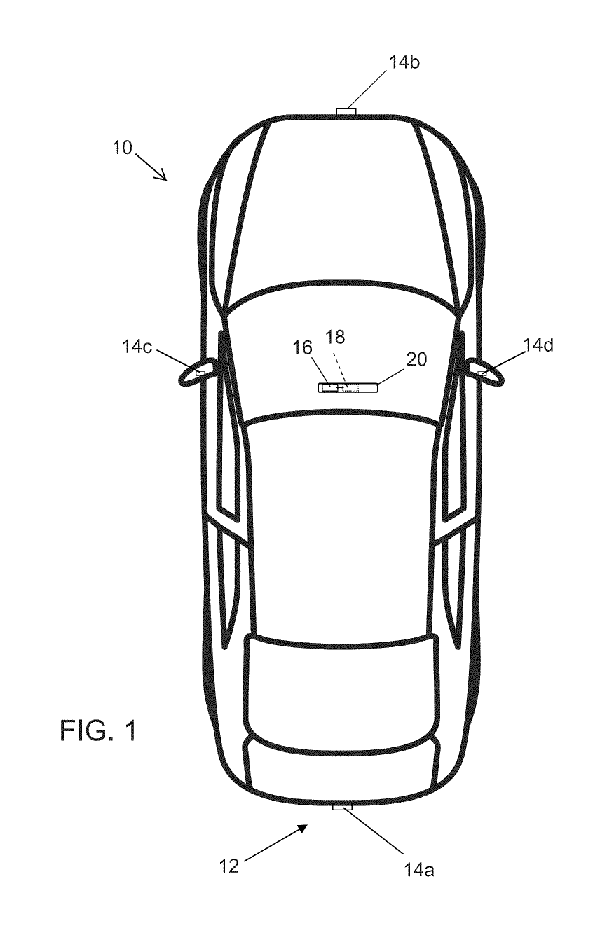

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sideward/rearward facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

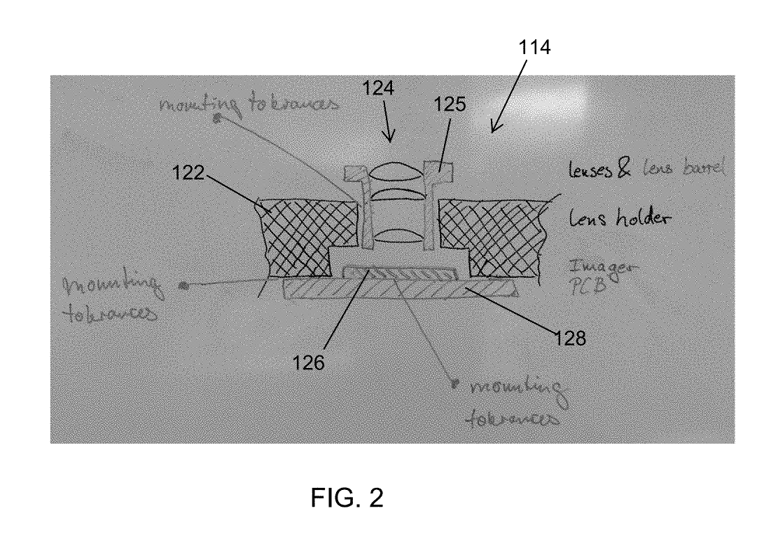

As shown in FIG. 2, a camera 114 typically has a lens holder or front housing portion 122 that houses or supports a lens assembly 124 (comprising a plurality of optic elements that may be disposed in or supported by a lens holder or lens barrel 125), and has an imager 126 disposed at a circuit element or printed circuit board (PCB) 128. The PCB 128 is disposed at the lens and the lens or PCB are adjusted relative to the other to optically align the lens with the imager, whereby an adhesive that holds the PCB relative to the lens holder or lens assembly is cured to hold the lens in optical alignment with the imager. In such assemblies, the imager and lens/lens barrel are usually built together with a lens holder. There are tolerances between the lens/lens barrel and lens holder, and the lens holder and PCB, and the PCB and imager. Thus, alignment of the lens relative to the imager requires a complex and time consuming alignment process and tool to ensure that the imager is at the right distances from the lens/lens barrel and parallel to (and aligned with) the lens/lens barrel.

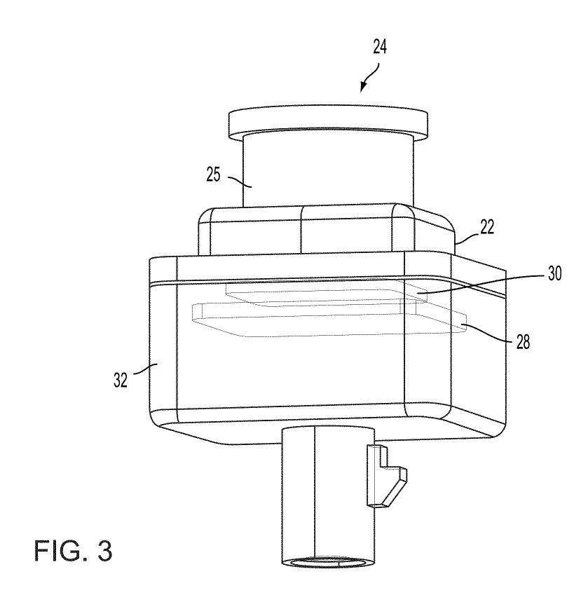

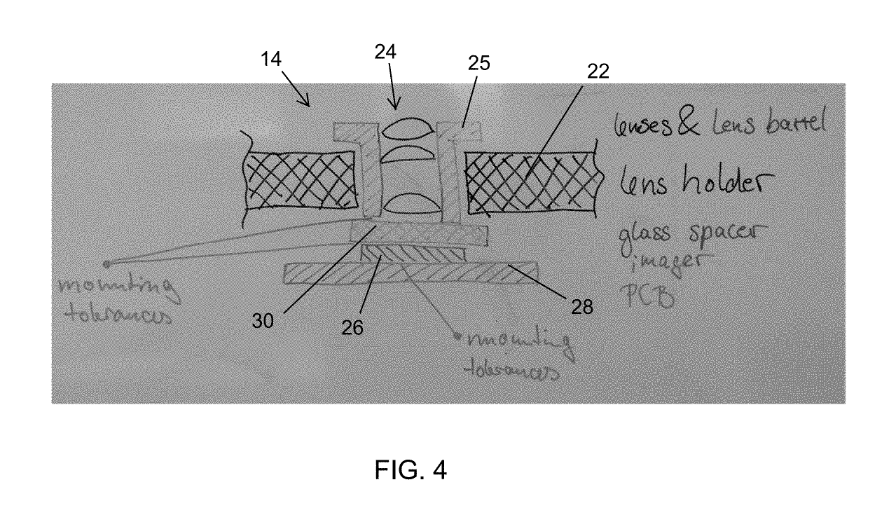

As shown in FIGS. 3 and 4, the vehicle camera 14 of the present invention includes a lens holder or front housing portion 22 that houses or supports a lens assembly 24 (comprising a plurality of optic elements that may be disposed in or supported by a lens holder or lens barrel 25), and has an imager 26 disposed at a circuit element or printed circuit board (PCB) 28, with a transparent glass plate or substrate or planar rigid spacer 30 disposed between the imager and the lens assembly. The PCB is disposed at the lens and the lens or PCB are adjusted relative to the other to optically align the lens with the imager, whereby an adhesive that holds the PCB relative to the lens holder or lens assembly is cured to hold the lens in optical alignment with the imager. A rear housing portion 32 (including a connector portion for electrically connecting the camera to an electrical connector of a vehicle when the camera is mounted at the vehicle) is attached at the front camera housing portion 22 to enclose and seal the circuit board (or circuit boards) and circuitry within the camera housing.

The planar rigid spacer 30 may comprise a planar transparent glass substrate having uniform thickness and having planar and parallel front and rear surfaces. When attached at the lens barrel or front housing portion, a circumferential portion of the front surface of the spacer may be adhesively attached at a circumferential portion or wall of the lens barrel or front housing portion. Similarly, when attached at the imager or circuit board (such as to a raised uniform thickness element at the circuit board that circumscribes the imager), a circumferential portion of the rear surface of the spacer may be adhesively attached at a circumferential portion of the imager or at a circumscribing raised element at the circuit board or the like.

Optionally, the spacer may comprise a transparent glass substrate that the imager views through when the spacer is attached or disposed between the imager and the lens. Optionally, the spacer may comprise a planar annulus that includes a circumferential planar ring-shaped spacer that has an opening therethrough. The front surface of the planar annulus may attach at the inner end of the lens barrel or front camera housing portion and the rear surface of the planar annulus may attach at the imager or at a circumscribing raised element at the circuit board or the like, such that the imager views through the opening of the annulus (such that the annulus need not be transparent).

The imager and lens/lens barrel are built together using a spacer in between, with the spacer preferably comprising a glass plate or substrate because such a glass plate can be highly planar and very accurate/uniform in thickness and very stable over a wide range of temperatures. The present invention thus provides for very precise positioning of the lens/lens barrel relative to the imager because the glass plate is glued or adhesively attached at the imager (such as to the imager or the PCB) and the lens/lens barrel is glued or adhesively attached at the glass plate. Thus, the glass plate provides the spacing between the lens and imager (and the glass plate is formed to a selected or appropriate thickness to accurately set the spacing between the lens and imager) and allows for movement of the lens or imager relative to the glass plate to optically align the lens and imager before curing the adhesive (with the smooth planar glass surface interface at the imager or the lens barrel allows for smooth sliding movement of the imager relative to the lens during the alignment process). A rear housing portion (not shown in FIG. 3) may be attached at said front housing portion to enclose and seal the imager and PCB (and other circuitry and circuit elements and electrical connectors) within the camera housing (such as by utilizing aspects of the camera assemblies described in U.S. Pat. No. 7,965,336, which is hereby incorporated herein by reference in its entirety).

Because of its high transparency to visible light and because it is available with a highly planar and stable and accurately measurable and uniform thickness, a glass plate/substrate is preferred. However, a highly planar and stable and accurately measurable and uniform thickness transparent plastic substrate (such as an acrylic transparent plastic substrate or a polycarbonate transparent plastic substrate) can, though less preferred, be used. A particular spacer (having a particular thickness) may be selected to provide the desired or appropriate or selected spacing between the imager and the lens. For example, various spacers (having respective various thicknesses) may be selected for respective particular applications, depending on the focal length of the lens or desired focusing of incident light onto the imager. When the appropriate or selected spacer is provided and disposed between the lens and the imager (and secured at the lens barrel or front camera housing portion and at the imager or circuit board) light incident at the lens and passing through the lens is properly imaged or focused onto the imager.

The assembly and adhesive attachment process of the present invention may utilize aspects of the cameras described in U.S. Pat. Nos. 8,542,451 and 9,277,104 (which are hereby incorporated herein by reference in their entireties), with the dual curing adhesive being disposed between the PCB/imager and the glass plate or between the lens barrel or lens holder or front housing portion and the glass plate. Optionally, the imager may be disposed directly at the rear surface of the glass substrate such as by utilizing aspects of the cameras described in U.S. Publication No. US-2016-0286103, which is hereby incorporated herein by reference in its entirety. In such a configuration, the lens barrel or lens holder may be adhesively attached at the front surface of the glass substrate and adjusted to optically align the imager relative to the lens before curing of the adhesive disposed between the lens barrel and the front surface of the glass substrate. Optionally, the imager or PCB may be adhered to the glass substrate or a rear camera housing portion that has the imager and PCB disposed therein may be adhered to the glass substrate.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525, which are hereby incorporated herein by reference in their entireties.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and vision systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Pat. Publication Nos. US 2010-0020170 and/or US-2009-0244361, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sideward or rearward directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A camera for a vision system for a vehicle, said camera comprising:
a front housing portion;
a lens assembly disposed at said front housing portion and comprising a plurality of lens optics;
an imager disposed at a circuit element;
a planar rigid spacer having a predetermined uniform thickness, said planar rigid spacer disposed between said lens assembly and said imager;
wherein at least a circumferential portion of a front surface of said planar rigid spacer is secured at a portion of said front housing portion and at least a circumferential portion of a rear surface of said planar rigid spacer is secured at one of said imager and said circuit element; and
wherein said planar rigid spacer accurately spaces said imager from said lens assembly and wherein the predetermined thickness of said planar rigid spacer is selected so that said lens assembly focuses incident light onto said imager.

2. The camera of claim 1, wherein said camera is configured to be disposed at a vehicle so as to have a field of view exterior of the vehicle.

3. The camera of claim 1, wherein said at least a circumferential portion of said front surface of said planar rigid spacer is adhesively attached at said portion of said front housing portion.

4. The camera of claim 1, wherein said at least a circumferential portion of said rear surface of said planar rigid spacer is adhesively attached at said one of said imager and said circuit element.

5. The camera of claim 1, wherein, prior to optical alignment of said lens assembly with said imager, one of (i) said at least a circumferential portion of said front surface of said planar rigid spacer is secured at said portion of said front housing portion and (ii) said at least a circumferential portion of said rear surface of said planar rigid spacer is secured at said one of said imager and said circuit element.

6. The camera of claim 5, wherein, after, said one of (i) said at least a circumferential portion of said front surface of said planar rigid spacer is secured at said portion of said front housing portion and (ii) said at least a circumferential portion of said rear surface of said planar rigid spacer is secured at said one of said imager and said circuit element, the lens assembly is optically aligned with said imager before the other of (i) said at least a circumferential portion of said front surface of said planar rigid spacer is secured at said portion of said front housing portion and (ii) said at least a circumferential portion of said rear surface of said planar rigid spacer is secured at said one of said imager and said circuit element.

7. The camera of claim 1, wherein said front and rear surfaces of said planar rigid spacer comprise planar surfaces.

8. The camera of claim 1, wherein said planar rigid spacer comprises a planar transparent glass substrate.

9. The camera of claim 1, wherein said planar rigid spacer comprises a planar annulus having an opening, wherein at least a portion of said front surface of said planar annulus is secured at said portion of said front housing portion and at least a portion of said rear surface of said planar annulus is secured at said circuit element such that said imager views through said opening.

10. The camera of claim 1, wherein said front housing portion comprises a lens barrel that houses said plurality of lens optics of said lens assembly and wherein said at least a circumferential portion of said front surface of said planar rigid spacer is secured at an end of said lens barrel.

11. The camera of claim 1, comprising a rear housing portion attached at said front housing portion to enclose said circuit element and said imager within said camera.

12. The camera of claim 11, wherein said rear housing portion comprises a connector portion for electrically connecting said camera to an electrical connector of a vehicle when said camera is mounted at the vehicle.

13. A camera for a vision system for a vehicle, said camera comprising:
a front housing portion;
a lens assembly disposed at a lens barrel of said front housing portion and comprising a plurality of lens optics;
an imager disposed at a circuit element;
a planar rigid spacer having a predetermined uniform thickness, said planar rigid spacer disposed between said lens assembly and said imager;
wherein said planar rigid spacer comprises a planar transparent glass substrate having planar front and rear surfaces that are parallel to one another;
wherein at least a circumferential portion of said front surface of said planar rigid spacer is secured at an end of said lens barrel of said front housing portion and at least a circumferential portion of said rear surface of said planar rigid spacer is secured at one of said imager and said circuit element; and
wherein said planar rigid spacer accurately spaces said imager from said lens assembly and wherein the predetermined thickness of said planar rigid spacer is selected so that said lens assembly focuses incident light onto said imager.

14. The camera of claim 13, wherein said camera is configured to be disposed at a vehicle so as to have a field of view exterior of the vehicle.

15. The camera of claim 13, wherein said at least a circumferential portion of said front surface of said planar rigid spacer is adhesively attached at said end of said lens barrel of said front housing portion.

16. The camera of claim 13, wherein said at least a circumferential portion of said rear surface of said planar rigid spacer is adhesively attached at said one of said imager and said circuit element.

17. The camera of claim 13, wherein, prior to optical alignment of said lens assembly with said imager, one of (i) said at least a circumferential portion of said front surface of said planar rigid spacer is secured at said end of said lens barrel of said front housing portion and (ii) said at least a circumferential portion of said rear surface of said planar rigid spacer is secured at said one of said imager and said circuit element.

18. The camera of claim 17, wherein, after, said one of (i) said at least a circumferential portion of said front surface of said planar rigid spacer is secured at said end of said lens barrel of said front housing portion and (ii) said at least a circumferential portion of said rear surface of said planar rigid spacer is secured at said one of said imager and said circuit element, the lens assembly is optically aligned with said imager before the other of (i) said at least a circumferential portion of said front surface of said planar rigid spacer is secured at said end of said lens barrel of said front housing portion and (ii) said at least a circumferential portion of said rear surface of said planar rigid spacer is secured at said one of said imager and said circuit element.

19. A camera for a vision system for a vehicle, said camera comprising:
a front housing portion;
a lens assembly disposed at said front housing portion and comprising a plurality of lens optics;
an imager disposed at a circuit element;
a rear housing portion attached at said front housing portion to enclose said circuit element and said imager within said camera;
a planar rigid spacer having a predetermined uniform thickness, said planar rigid spacer disposed between said lens assembly and said imager;
wherein at least a circumferential portion of a front surface of said planar rigid spacer is secured at a portion of said front housing portion and at least a circumferential portion of a rear surface of said planar rigid spacer is secured at one of said imager and said circuit element;
wherein said planar rigid spacer accurately spaces said imager from said lens assembly and wherein the predetermined thickness of said planar rigid spacer is selected so that said lens assembly focuses incident light onto said imager;
wherein said camera is configured to be disposed at a vehicle so as to have a field of view exterior of the vehicle; and
wherein said rear housing portion comprises a connector portion for electrically connecting said camera to an electrical connector of a vehicle when said camera is mounted at the vehicle.

20. The camera of claim 19, wherein, prior to optical alignment of said lens assembly with said imager, one of (i) said at least a circumferential portion of said front surface of said planar rigid spacer is secured at said portion of said front housing portion and (ii) said at least a circumferential portion of said rear surface of said planar rigid spacer is secured at said one of said imager and said circuit element, and wherein, after, said one of (i) said at least a circumferential portion of said front surface of said planar rigid spacer is secured at said portion of said front housing portion and (ii) said at least a circumferential portion of said rear surface of said planar rigid spacer is secured at said one of said imager and said circuit element, the lens assembly is optically aligned with said imager before the other of (i) said at least a circumferential portion of said front surface of said planar rigid spacer is secured at said portion of said front housing portion and (ii) said at least a circumferential portion of said rear surface of said planar rigid spacer is secured at said one of said imager and said circuit element.
